(19) United States
(12) Patent Application Publication
(10) Pub. No.: US 2008/0170163 A1
(43) Pub. Date: Jul. 17, 2008

(54) METHOD AND APPARATUS FOR SELECTING TELEVISION CHANNEL

(75) Inventors: Chih-Hao Liang, Taipei (TW); Li-Hsiang Liao, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: ASUSTeK COMPUTER INC., Taipei (TW)

(21) Appl. No.: 11/971,196

(22) Filed: Jan. 8, 2008

(30) Foreign Application Priority Data
Jan. 12, 2007 (TW) 96101257

(51) Int. Cl. H04N 5/455; H04N 5/50

(52) U.S. Cl. 348/726; 348/731

(57) ABSTRACT

A method and an apparatus for selecting a television channel are disclosed. In the method, a receiving unit is used to scan analog television signals and digital television signals to obtain analog television channels and digital television channels. Then, these television channels are integrated into a set of channel list. Afterward, a corresponding filter unit is established according to the selected television channel, and the related hardware is driven to receive the corresponding television signals according to the filter unit. Therefore, when selecting television channel, users need not designate the kind of the television channel ahead. And then, it will be faster and more convenient in operation.

### CROSS-REFERENCE TO RELATED APPLICATION

This application claims the priority benefit of Taiwan application serial no. 96101257, filed on Jan. 12, 2007. The entirety of the above-mentioned patent application is hereby incorporated by reference herein and made a part of this specification.

### BACKGROUND OF THE INVENTION

1. Field of the Invention

The invention relates to a method and an apparatus for selecting a television channel and, more particularly, to a method and an apparatus for selecting a television channel by automatically switching between an analog television channel and a digital television channel.

2. Description of the Related Art

In recent years, with the development of the science and technology, a television program can be enjoyed via a television box or television card cooperating with a display. Thus, a television set is not necessary. Moreover, since the telecommunication and compression technology change with each passing day, the traditional analog television broadcasting has developed toward the digital television broadcasting gradually. Therefore, one can switch between an analog television channel and a digital television channel as long as he has both an analog television tuner and a digital television tuner.

Generally speaking, when a television tuner can process signals of both analog television channels and digital television channels, a user can switch between these two kinds of channels by executing a multimedia playing program. After the program being executed, the display, such as a screen of a television set or a computer, displays an initial setting menu including two options, a “digital television mode” option and an “analog television mode” option, for a user to select. The display displays a channel list of digital television channels if the user selects the digital television mode, and a channel list of analog television channels if the user selects the analog television mode.

Since the user has to select the television mode at the initial setting menu, when watching television, if the user wants to switch to the other kind of the television channel, analog television channel or digital television channel, he needs to switch back to the initial setting menu. In other words, he has to select the kind of the television channel first, and then select the television channel he wants to watch.

As stated above, the conventional method for watching digital television channel and analog television channel is quite inconvenient in use. Moreover, memorizing the kinds of the television channels will be more difficult with the increasing of the number of the digital television channels.

### BRIEF SUMMARY OF THE INVENTION

Therefore, the invention provides an apparatus for selecting a television channel, so that users can switch between two kinds of television channels fast.

The invention provides a method for selecting a television channel, so that users can switch between two kinds of television channels more conveniently.

The invention provides an apparatus for selecting a television channel, and the apparatus includes a receiving unit, a storage unit and a filter unit. The receiving unit scans a plurality of analog television signals and digital television signals according to a scanning command to obtain a channel list, and the channel list includes a plurality of analog television channels and digital television channels. The storage unit stores the channel list. When any television channel in the channel list is selected, the filter unit receives the corresponding television signals according to the television channel.

The invention also provides a method for selecting a television channel. First, scanning a plurality of analog television signals and digital television signals according to a scanning command to obtain a channel list; then, storing the channel list including a plurality of analog television channels and digital television channels; after that, detecting whether any of television channels in the channel list has been selected; at last, establishing a corresponding filter unit according to the selected television channel in the television list to modulate the frequency.

In the invention, the analog television channels and digital television channels are integrated into a set of channel list, and a corresponding filter unit is established according to a selected television channel. The related hardware is driven according to the filter unit to receive the corresponding television signals and modulate the frequency. In this way, when a television channel is selected, the kind of the television channel need not be designated first. Thus, Users can use the apparatus more convenient and faster.

These and other features, aspects, and advantages of the present invention will become better understood with regard to the following description, appended claims, and accompanying drawings.

### BRIEF DESCRIPTION OF THE DRAWINGS

FIG. 1 is a block diagram showing an apparatus for selecting a television channel of an embodiment of the invention.

FIG. 2 is a block diagram showing an apparatus for selecting a television channel of another embodiment of the invention.

FIG. 3 is a flowchart showing a method for selecting a television channel of an embodiment of the invention.

FIG. 4 is a block diagram showing an analog filter unit of an embodiment of the invention.

FIG. 5 is a block diagram showing a digital filter unit of an embodiment of the invention.

### DETAILED DESCRIPTION OF THE EMBODIMENTS

The following embodiment takes DirectShow technology developed by the United States Microsoft company as example. DirectShow technology is used to drive the corresponding hardware and pick up multimedia streaming information such as a television signal. Filters compose the basic frame of DirectShow technology and drive the corresponding hardware. DirectShow establishes a filter graph according to the connecting relationship of a plurality of filters, and achieves the operating function of receiving, editing and transmitting the television signals via the filter graph. In the following embodiment, the filter unit which is, for example, a filter graph is composed of modules which are, for example, filters. Since persons having ordinary skills in the art can use the invention in other arts according to their need, the technology herein is not limited to the DirectShow technology.

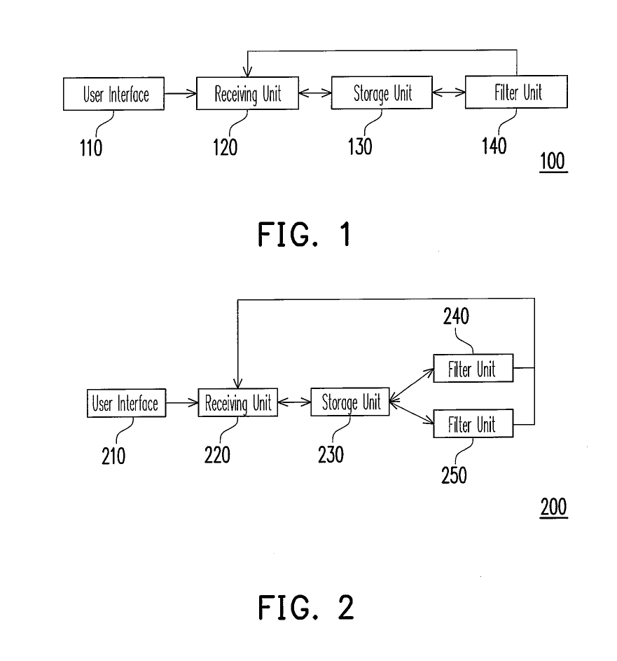

FIG. 1 is a block diagram showing an apparatus for selecting a television channel of one embodiment of the invention. Refer to FIG. 1. The apparatus 100 for selecting a television channel includes a user interface 110, a receiving unit 120, a storage unit 130 and a filter unit 140. The user interface 110 can be used to receive a selected television channel, the receiving unit 120 selects the television signals according to the selected television channel, and the filter unit 140 receives corresponding television signals according to the selected television channel.

The user interface 110 can also be used to receive a scanning command and transmit the scanning command to the receiving unit 120. When initially used, the apparatus 100 for selecting a television channel can receive the scanning command via the user interface 110 to execute the operation of scanning the television channels. When the scanning command has been executed, the apparatus 100 for selecting a television channel can receive the channel selecting command (namely the selected television channel) via the user interface 110 to select the television channel. The user interface 110 is, for example, a mouse, a keyboard, or a remote controller, etc.

The receiving unit 120 is used to scan a plurality of analog television signals and digital television signals according to the scanning command, and determine the television channels according to the frequency range of the analog television signals and digital television signals to obtain analog television channels and digital television channels. In other words, the receiving unit 120 is used to scan television channels to obtain the channel list and can receive the television signals respecting the specific frequency range according to the channel selecting command. The receiving unit 120 is, for example, a television card or television box.

The storage unit 130 is used to store the channel list including a plurality of analog television channels and digital channels. That is, the storage unit 130 is used to store various television channels obtained by analyzing the analog television signals and the digital television signals by the receiving unit 120 as a channel list.

When any television channel in the channel list is selected, the filter unit 140 is used to receive the corresponding television signals according to the television channel. That is, the filter unit 140 registers the module of the related hardware (similar with the function of the driver) at the operating system according to the kind of the television channel (analog television channel or digital television channel) which will be received, and connects various modules together according to the data transmitting flow relationship between various modules, and stores various modules and the connecting relationships thereof into the storage unit 130 so that they can be used by the same kind of the television channels next time.

When the apparatus for selecting television channels 100 only has a tuner (not shown), generally speaking, the tuner can deal with both analog television signals and digital television signals. Moreover, since the analog television signals should be converted to the digital television signals before the next operation, the filter unit 140 is a digital filter unit.

If the apparatus for selecting television channels 100 of the embodiment includes two tuners (not shown), the apparatus for selecting unit 100 can include two filter units 140. FIG. 2 is a block diagram showing an apparatus for selecting television channels of another embodiment of the invention. Referring to FIG. 2, the apparatus for selecting television channels 200 includes a user interface 210, a receiving unit 220, a storage unit 230, a filter unit 240 and a filter unit 250, wherein the functions of the user interface 210, receiving unit 220 and storage unit 230 are same or similar with that of the user interface 110, receiving unit 120 and storage unit 130 of the previous embodiment. Thus, they will not be described for concise purpose.

When the apparatus for selecting television channels 200 has two tuners (not shown), it can include two filter units (240 and 250). The filter unit 240 and filter unit 250 are used to receive different kinds of television signals. For example, if the filter unit 240 is an analog filter unit, the filter unit 250 is a digital filter unit. When the received television signals are analog television signals, the filter unit 240 is used to receive the analog television signals, and when the received television signals are digital television signals, the filter unit 250 is used to receive the digital television signals.

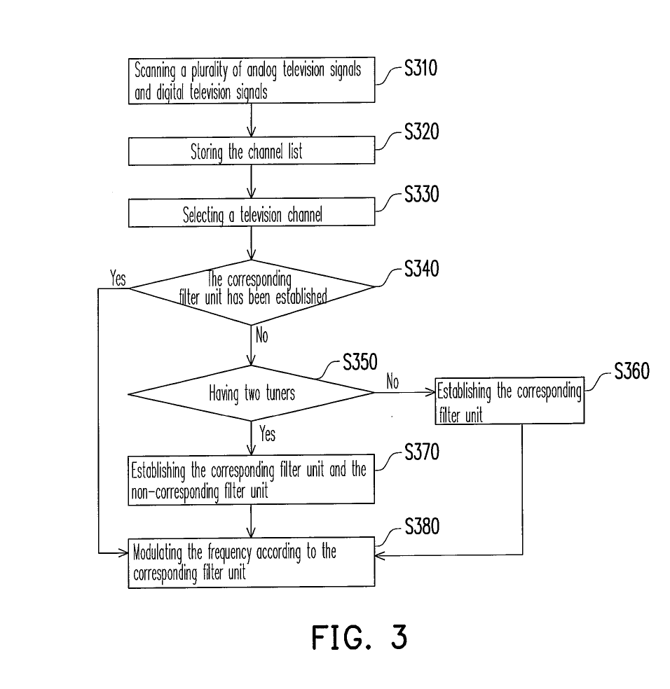

The detailed steps of the method for selecting television channels of the invention will be further described with the apparatus for selecting television channels 100. FIG. 3 is a flowchart of the method for selecting television channels of one embodiment of the invention. Referring to FIG. 1 and FIG. 3 simultaneously, first, step S310 is scanning a plurality of analog television channels and digital television channels by receiving unit 120. In other word, the step S310 is notifying the receiving unit 120 to scan the analog television signals and digital television signals according to the scanning command received by the user interface 110 and analyze the frequency range of the analog television signals and digital television signals.

Generally speaking, when the receiving unit 120, such as a television card or a television box, is installed, users usually make the channels scanned first to seek the effective television channels before they watch a television program. The television signals can be transmitted by terrestrial broadcasting, cable or satellite transmitting. The television signals from various sources can be sought by scanning the channels, and the analog television signals and digital television signals can be sought at the same time. Moreover, since the television signals have their own frequency range, the received television signals are analyzed by receiving unit 120, and the television channels with different television signals are distinguished according to the frequency range.

After that, step S320 is integrating the analog television channels and digital television channels scanned by the receiving unit 120 into a set of channel list and storing the channel list in the storage unit 130. Since some of the analog television channels may be repeated by some digital television channels, the repeated analog television channels and digital television channels are integrated in the same channel list. Thus, users can select the television channels conveniently.

For example, the channel 1 to channel 200 in the channel lists can be set to store analog television channels, and the channels after the channel 200 can be set to store digital television channels. In another example, as for the personal computer installed with a television card, if the analog television channels include the channel 10, and the digital television channels also include the channel 10, a menu can be set at the channel 10 in the channel list. Thus, when the right mouse button is clicked, the function menu is displayed, and the kind of the television channel can be selected. The above is used to make the description more concise, and the integrating method of the channel list of the embodiment is not restricted.

Next, please continue to refer to FIG. 1 and FIG. 3. The step S330 is detecting whether any television channel of the channel list has been selected. In other words, the step S330 is receiving a channel selecting command via the user interface 110, and the user gives the channel selecting command to select the television channel he wants to watch. After that, when the system detects that a television channel has been selected, the step S340 is determining whether a corresponding filter unit 140 has been established by the receiving unit 120. That is, the step S340 is determining whether each of the modules of the filter unit 140 and the connecting relationship thereof exist in the storage unit 130.

The filter unit 140 is established according to the kind of the television channels to make a plurality of related modules connect with each other. Detailed speaking, the corresponding hardware is operated by each of modules of the filter unit 140, and the filter unit 140 is established according to the data transmitting flow between each of the modules.

Please continue to refer to FIG. 1 and FIG. 3. If the filter unit 140 is established, the step S380 is executed, and the operation of modulating the frequency is executed according to filter unit 140. For example, if the kind of the present selected television channel is the same with that of the previous selected television channel, the filter unit 140 is established after the previous channel selecting command is received. Thus, the step S380 can be directly executed, and the related hardware is driven according to filter unit 140 to receive the corresponding television signals to modulate the frequency. Otherwise, the filter unit 140 can be established in advance. The corresponding television signals can be received directly according to the filter unit 140 after the channel selecting command is received. The above is optional according to the users' need, and the range thereof is not restricted.

If the filter unit 140 is not established, the step S350 that is determining whether the apparatus for selecting television channels 100 has two tuners (not shown) is executed. If the apparatus for selecting television channels 100 only has one tuner (not shown), the step S360 is executed. If the apparatus for selecting television channels 100 has two tuners (not shown), the step S370 is executed.

The step S360 is establishing the filter unit 140 according to the kind of the selected television channel. Since the apparatus for selecting television channels 100 only has one tuner (not shown), the established filter unit 140 is a digital filter unit.

If the apparatus for selecting television channels 100 has two tuners (not shown), refer to FIG. 2 and FIG. 3. The step S370 can be establishing corresponding filter unit 240 according to the kind of the selected television channel, and optional establishing non-corresponding filter unit 250 in advance. In other words, the non-corresponding filter unit 250 is established after the corresponding filter unit 240 is established.

For example, the established filter unit 240 is an analog filter unit if the selected television channel is an analog television channel or a digital filter unit if the selected television channel is a digital television channel. Moreover, if the selected television channel is an analog television channel, a digital filter unit can be established in advance after the analog filter unit is established. Thus, users can switch between an analog filter unit and a digital filter unit according to their need. That is, one tuner (not shown) cooperates with one filter unit (240 or 250), and one filter unit is used to receive analog television signals, while the other is used to receive digital television signals. In this way, the time for switching between the television channels can be shorter.

The analog filter unit and digital filter unit of the previous embodiment will be described with examples, respectively, hereinbelow.

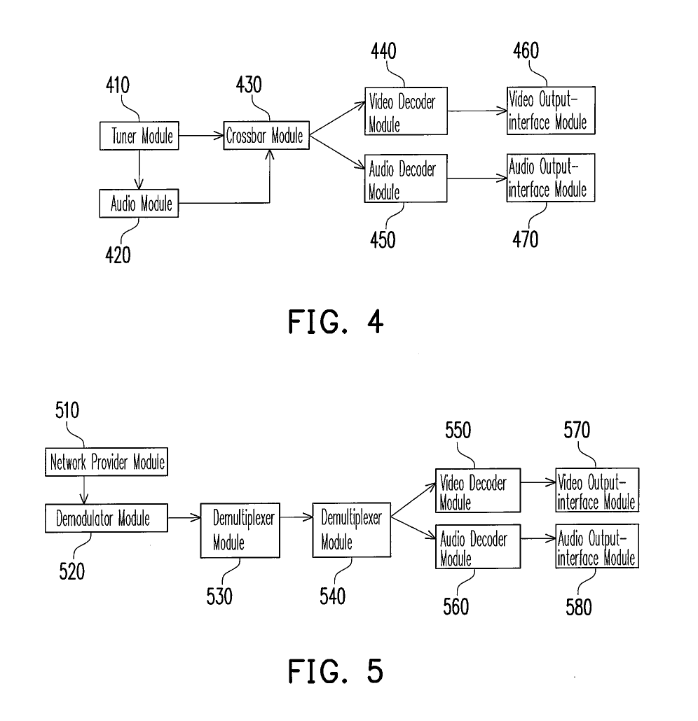

FIG. 4 is a block diagram showing an analog filter unit of an embodiment of the invention. Refer to FIG. 4. The analog filter unit is used to receive analog television signals, and the analog filter unit consists of various modules including a tuner module 410, an audio module 420, a crossbar module 430, a video decoder module 440, an audio decoder module 450, a video output-interface module 460, an audio output-interface module 470 and so on. The analog filter unit is established according to the data transmission flow between each of the modules (namely the arrow direction in the figures). First, the tuner module 410 receives the analog television signals, amplifies the signals, reduces the frequency for the signals to modulate the frequency to the correct television channel, and separates the signals into video signals and audio signals. After that, the audio module 420 receives the audio signals, and the crossbar module 430 selects an input source of the video signals, wherein the input sources includes an AV terminal, an S-Video terminal or a television terminal, and the selected source of the television video signals herein is a television terminal. Then, after the audio signals and video signals are converted to digital television signals, respectively, by the video decoder module 440 and audio decoder module 450, the digital television signals are transmitted to the corresponding apparatus, such as a display or an amplifier, respectively, by the video output-interface module 460 and the audio output-interface module 470.

FIG. 5 is a block diagram showing a digital filter unit of an embodiment of the invention. Referring to FIG. 5, the digital filter unit is used to receive the digital television signals and consists of the modules including a network provider module 510, a tuner module 520, a demodulator module 530, a demultiplexer module 540, a video decoder module 550, an audio decoder module 560, a video output-interface module 570, an audio output-interface module 580 and so on, wherein the network provider module 510 is responsible for the entering of the digital television signals and configures the tuner module 520. Then, the tuner module 520 modulates the frequency to the correct television channel, and the demodulator module 530 demodulates and transmits the demodulated digital television signals to the demultiplexer module 540. After that, the demultiplexer module 540 demultiplexes the digital television signals to the video signals and audio signals. Next, the video signals and audio signals are decompressed by the video decoder module 550 and audio decoder module 560, respectively, and transmitted to the corresponding apparatus to output by the video output-interface module 570 and audio output-interface module 580, respectively.

Please continue to refer to FIG. 2 and FIG. 3. At last, the step S380 is executed. The corresponding hardware is driven according to corresponding filter unit (240 or 250) to receive the corresponding television signals and modulate the frequency to output the selected television channel for the users.

To sum up, the apparatus for selecting television channels and method thereof have at least the following advantages:

In the invention, the corresponding filter unit is established according to the kind of a television channel. The kind of a television channel can be switched according to the need of the users automatically. Thus, the television channels can be switched fast.

The analog television channels and digital television channels are integrated and stored as a set of channel list to provide a more convenient operating method.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. An apparatus for selecting a television channel comprising:
a receiving unit for scanning a plurality of analog television signals and digital television signals according to a scanning command to obtain a channel list, the channel list comprising a plurality of analog television channels and digital television channels;
a storage unit for storing the channel list; and
a first filter unit, wherein when any of the television channels in the channel list is selected, the first filter unit receives corresponding television signals according to the selected television channel.

2. The apparatus for selecting a television channel according to claim 1, wherein the first filter unit is a digital filter unit.

3. The apparatus for selecting a television channel according to claim 2, wherein the digital filter unit comprises:
a network provider module for being responsible for the entering of one of the digital television signals;
a first tuner module for receiving one of the digital television signals;
a demodulator module for demodulating one of the digital television signals;
a demultiplexer module for demultiplexing one of the digital television signals to a video television signal and an audio television signal;
a first video decoder module for decoding the video television signals;
a first audio decoder module for decoding the audio television signals;
a first video output-interface module for outputting the decoded video television signals; and
a first audio output-interface module for outputting the decoded audio television signals.

4. The apparatus for selecting a television channel according to claim 1, the apparatus further comprising a second filter unit which is an analog filter unit.

5. The apparatus for selecting a television channel according to claim 4, wherein the analog filter unit comprises:
a second tuner module for receiving one of the analog television signals and separating one of the analog television signals to a video television signal and an audio television signal;
an audio module for receiving the audio television signal;
a crossbar module for receiving the video television signal;
a second video decoder module for decoding the video television signal;
a second audio decoder module for decoding the audio television signal;
a second video output-interface module for outputting the decoded video television signal; and
a second audio output-interface module for outputting the decoded audio television signal.

6. The apparatus for selecting a television channel according to claim 1, the apparatus further comprising a user interface for receiving the scanning command.

7. A method for selecting a television channel comprising the steps of:
scanning a plurality of analog television signals and digital television signals according to a scanning command;
storing a channel list comprising a plurality of analog television channels and digital television channels;
detecting whether any of the television channels in the channel list is selected; and
when any of the television channels in the channel list is selected, establishing at least one first filter unit according to the selected television channel to modulate the frequency.

8. The method for selecting a television channel according to claim 7, the method further comprising receiving the scanning command.

9. The method for selecting a television channel according to claim 7, the method further comprising storing the first filter unit so that it can be used when the same kind of the selected television channel is selected next time.

10. The method for selecting a television channel according to claim 9, wherein the first filter unit is a digital filter unit.

11. The method for selecting a television channel according to claim 7, the method further comprising establishing a second filter unit which is an analog filter unit and storing the second filter unit when the apparatus has a first tuner and a second tuner.
